(19) United States
(12) Patent Application Publication
(10) Pub. No.: US 2014/0164851 A1
(43) Pub. Date: Jun. 12, 2014

(54) Fault Processing in a System

(71) Applicants: Simon Pelly, Bristol (GB); Alastair Slater, Chepstow (GB)

(72) Inventors: Simon Pelly, Bristol (GB); Alastair Slater, Chepstow (GB)

(21) Appl. No.: 14/235,006

(22) PCT Filed: Nov. 4, 2011
(86) PCT No.: PCT/US2011/059275

§ 371 Date: Jan. 24, 2014

(51) Int. Cl. G06F 11/07

(52) U.S. Cl. CPC G06F 11/0793
USPC 714/48

(57) ABSTRACT

A status indication regarding operation of a first subsystem is provided. A fault of the first subsystem is detected. In response to detecting the fault, a status indication is updated, and a resource used by the first subsystem is freed up.

### BACKGROUND

A system can have various subsystems for performing respective tasks. Examples of systems include storage systems, processing systems, or other types of systems. During operation of a system, some subsystems may experience faults, which can cause errors in the system.

### BRIEF DESCRIPTION OF THE DRAWINGS

Some embodiments are described with respect to the following figures:

FIGS. 1 and 2 are block diagrams of example arrangements according to various implementations;

FIG. 3 is a flow diagram of a process according to some implementations;

FIGS. 4 and 5 illustrate example status indications according to some implementations; and

FIG. 6 is a block diagram of a monitoring subsystem according to some implementations.

### DETAILED DESCRIPTION

Subsystems within a system can provide status indications regarding operations of the corresponding subsystems. A “subsystem” can refer to a process (e.g. machine-readable instructions) that runs within a physical machine, or alternatively, a “subsystem” can refer to a machine (including hardware components and machine-readable instructions) or any part of the machine. In some examples, the status indications can indicate respective states of the subsystems, such as “starting” (a subsystem is starting up), “running” (the subsystem is currently running), and so forth (other example states are discussed further below).

A subsystem can experience a fault (such as the subsystem failing or a component of the subsystem not operating correctly). Upon experiencing the fault, the subsystem may not be able to update its status indication, which can result in the status indication no longer being accurate after the subsystem has experienced the fault. An incorrect status indication provided by a subsystem can cause an error in the overall system. For example, a group of subsystems may be sensitive to an ordering or sequencing constraint, where a certain operation of one such subsystem is to occur after a corresponding operation of another subsystem (e.g. one subsystem is to start up after another subsystem has already started up). The group of subsystems can be part of a stack of subsystems, where the stack imposes the ordering or sequencing constraint on the subsystems within the stack. Thus, if a first subsystem in the stack indicates that it is operating correctly (even though the first subsystem is not), then a second subsystem that is to follow the first subsystem may incorrectly proceed with the second subsystem's operation based on the incorrect assumption that the first subsystem has completed its operation successfully. As another example, a first subsystem may attempt to access a second subsystem whose status indication indicates that the second subsystem is operating normally, but when in fact the second subsystem has failed. The inability to reach the second subsystem can cause an error at the first subsystem as well as other parts of the overall system. Moreover, when a particular subsystem has failed but its status indication indicates that it is operating normally, resources that were used by the failed subsystem can continue to be allocated to the failed subsystem, which makes the allocated resources unavailable to other subsystems.

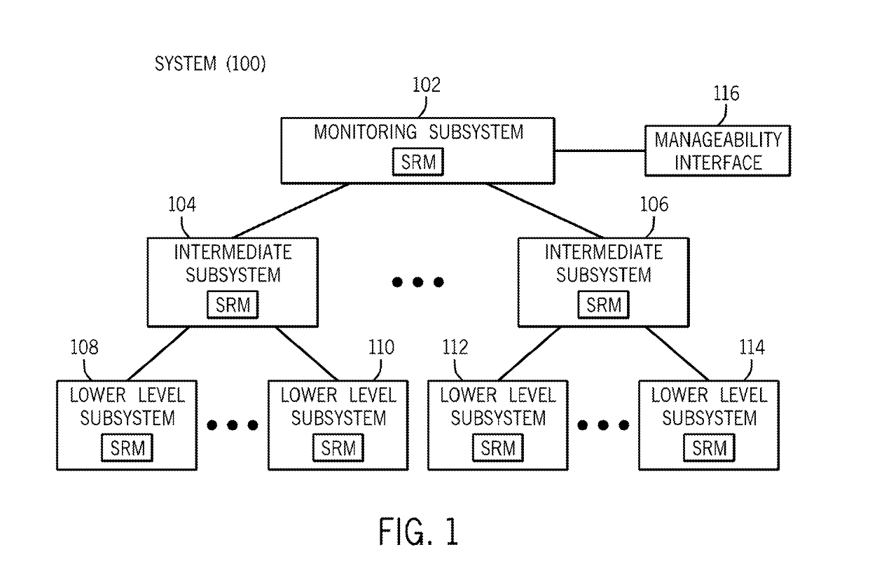

FIG. 1 illustrates an example system 100 according to some implementations. The system can have various subsystems arranged in a hierarchy. The various subsystems shown in FIG. 1 can be part of one physical machine (e.g. computer system, storage system, communications system, etc.) or can be part of a distributed arrangement of physical machines. A top level of the hierarchy includes a monitoring subsystem 102, an intermediate level of the hierarchy includes intermediate subsystems 104 and 106, and a lower level of the hierarchy includes subsystems 108, 110, 112, and 114.

Although FIG. 1 shows a system having three hierarchical levels, it is noted that in other implementations, other example arrangements can be employed, including arrangements that employ just two hierarchical levels or more than three hierarchical levels. The lower level subsystems 108 and 110 are associated with the intermediate subsystem 104 (e.g. the lower level subsystems 108 and 110 can be processes that run in the intermediate subsystem 104). Similarly, the lower level subsystems 112 and 114 are associated with the intermediate subsystem 106.

As shown in FIG. 1, each of the subsystems includes a status reporting module (labeled “SRM” in each subsystem) that is capable of providing a corresponding status indication. The status indication in some implementations can be in the form of a status file, such as a file according to an XML (Extensible Markup Language) format or other format.

A status indication provided by the status reporting module of any of the intermediate and lower level subsystems (104, 106, 108, 110, 112, 114) can be monitored by the monitoring subsystem 102. In some examples, the monitoring subsystem 102 can provide “watchdog” activities. Watchdog activities can include monitoring the status of various subsystems in a system, and upon detection of some fault in any of the subsystems, tasks can be performed to address such faults.

The monitoring subsystem 102 can be part of a machine separate from the machine(s) implementing the intermediate and lower level subsystems. Alternatively, the monitoring subsystem 102 can be a monitoring process running on the same machine as one or multiple ones of the intermediate and lower level subsystems.

In addition to the status indications of the intermediate and lower level subsystems being accessible by the monitoring subsystem 102, note that the status indication of a particular subsystem is also accessible by a higher-level subsystem associated with the particular subsystem. For example, the status indication reported by the status reporting module of the lower level subsystem 112 or 114 is accessible by the intermediate subsystem 106.

The monitoring subsystem 102 also includes a status reporting module that can provide a status indication to a manageability interface 116, which can include a user interface system (such as a management console through which a user, such as an administrator, is able to determine the status of various subsystems of the system 100). Alternatively or additionally, the manageability interface 116 can include a different type of system, such as an automated system that can take automatic remedial actions in response to the status indication provided by the monitoring subsystem 102.

In accordance with some implementations, a higher level subsystem can monitor operation of a lower level subsystem, for determining whether or not the status indication reported by the lower level subsystem is accurate. For example, the monitoring subsystem 102 can intermittently poll each of the intermediate and lower level subsystems (104, 106, 108, 110, 112, and 114) for determining whether the corresponding subsystem is operational. In alternative examples, instead of a monitoring subsystem 102 polling a lower level subsystem, a heartbeat mechanism can be employed in which the lower level subsystem intermittently sends heartbeat messages to the monitoring subsystem 102. Failure to receive a heartbeat message within a predefined time interval is an indication that the lower level subsystem has experienced a fault. The polling or communication of heartbeat messages can be performed on a periodic basis, or according to some other criterion.

In other implementations, instead of the monitoring subsystem 102 performing the polling or receiving of heartbeat messages, an intermediate subsystem 104 or 106 can perform the polling of each respective lower level subsystem 108, 110, 112, or 114, or receiving of heartbeat messages from the respective lower level subsystem. In such implementations, it is the intermediate system that is able to identify a fault status of a lower level subsystem.

In some examples, if it is detected that the status indication of a particular subsystem is inaccurate (e.g. the status indication of the particular subsystem indicates normal operation of the particular subsystem even though the particular subsystem has experienced a fault), then the status indication output by the monitoring subsystem 102 can be updated to indicate that a fault has occurred. In an example, the status indication output by the lower level subsystem 108 may indicate normal operation even though the lower level subsystem 108 has experienced a fault. A status indication indicating a “normal operation” of a subsystem can refer to an indication that the subsystem is operating in an expected manner (e.g. the subsystem is responding to a polling request with a success indication, or the subsystem is sending a heartbeat message at an expected time interval). Upon detecting the fault status of the lower level subsystem 108, such as through either the polling or heartbeat mechanism noted above, the monitoring subsystem 102 can update its status indication (that is output to the manageability interface 116) to reflect the fault.

In addition, the monitoring subsystem 102 may update the status indication output by the faulty lower level subsystem 108 to reflect the fault status of the lower level subsystem 108.

In other examples, upon detection of the faulty status of the lower level subsystem 108, the status indication reported by the intermediate subsystem 104 can be updated to reflect that the intermediate subsystem 104 is associated with a lower level subsystem that has experienced a fault. Update of the status indication of the intermediate subsystem 104 can be performed by the monitoring subsystem 102, in some implementations. In other implementations, the status indication of the intermediate subsystem 104 can be updated by the intermediate subsystem 104 itself.

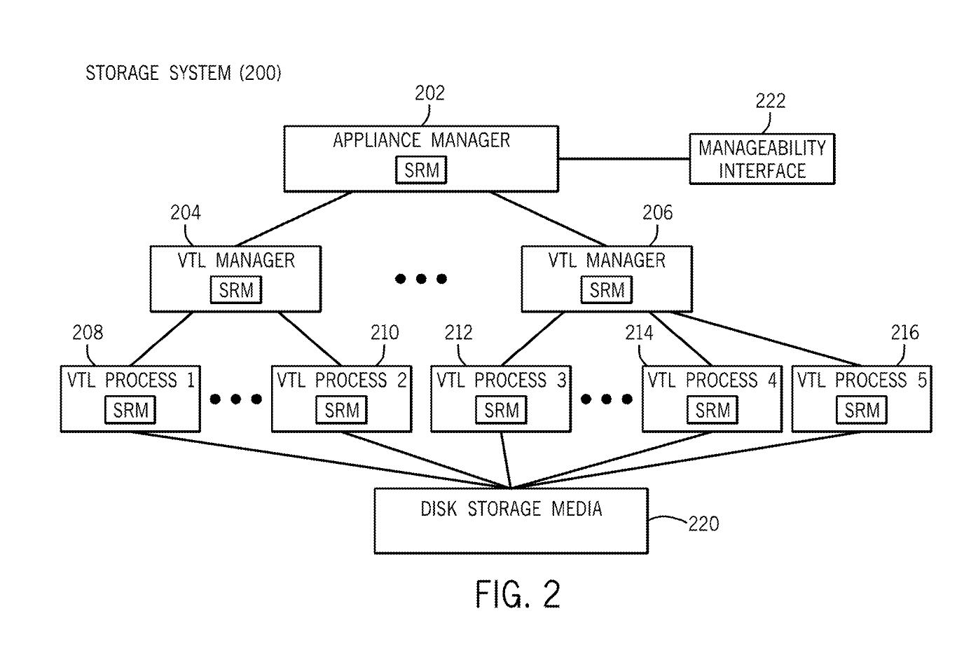

FIG. 2 is a block diagram of another example system 200, which can be a storage system according to some implementations. The storage system 200 includes an appliance manager 202, and various virtual tape library (VTL) managers 204 and 206. In addition, there can be various VTL processes that are managed by the VTL managers 204 and 206, including VTL processes 208, 210, 212, 214, and 216. A VTL (or virtual tape library) can refer to a data storage subsystem that employs a storage component (other than tape storage media) to virtualize a tape library that includes tape storage media. The VTL is implemented with various discrete VTL processes, such as those shown in FIG. 2. A VTL process is a process within a VTL that controls transport of data (during read or write access) in the VTL. The various discrete VTL processes are able to emulate a physical tape library and its corresponding behaviors or tasks (note that different ones of the VTL processes 208, 210, 212, 214, and 216 can emulate different physical tape library behaviors or tasks). A VTL manager is responsible for managing one or multiple VTL processes—note that the VTL manager is not involved in the data transport in the VTL.

In the example of FIG. 2, the VTL manager 204 manages VTL processes 208 and 210, while the VTL manager 206 manages VTL processes 212, 214, and 216. In some examples, the VTL manager 204 and associated VTL processes 208 and 210 can be part of a corresponding machine, such as a storage server. Similarly, the VTL manager 206 and its VTL processes 212, 214, and 216 can be part of another corresponding machine, such as a storage server. In other examples, the VTL managers 204 and 206 (and their respective VTL processes) can be part of the same machine.

The storage system 200 also includes disk storage media 220, which can be implemented with one or multiple storage devices, such as an array of storage devices. Respective VTL processes can access (read or write) data on the disk storage media 220.

The appliance manager 202 can perform predefined management tasks for the storage system 200. In some examples, the appliance manager 202 can manage the “disk-to-disk” storage of data of a client or host device (not shown in FIG. 2) onto the disk storage media 220 in the storage system 200 of FIG. 2. In different implementations, the appliance manager 202 can perform other management tasks.

The appliance manager 202, VTL managers 204 and 206, and VTL processes 208, 210, 212, 214, and 216 are considered subsystems of the storage system 200. Each of the appliance manager, VTL managers, and VTL processes can include a status reporting module (SRM) for reporting a corresponding status indication. The various subsystems of the storage system 200 can correspond to respective subsystems shown in FIG. 1. Although three hierarchical levels of subsystems are shown in FIG. 2, note that in alternative examples, the storage system 200 can include a different hierarchical arrangement having a different number of levels.

The appliance manager 202 is able to report the status indication generated by its status reporting module to a manageability interface 222, which is similar to the manageability interface 116 of FIG. 1.

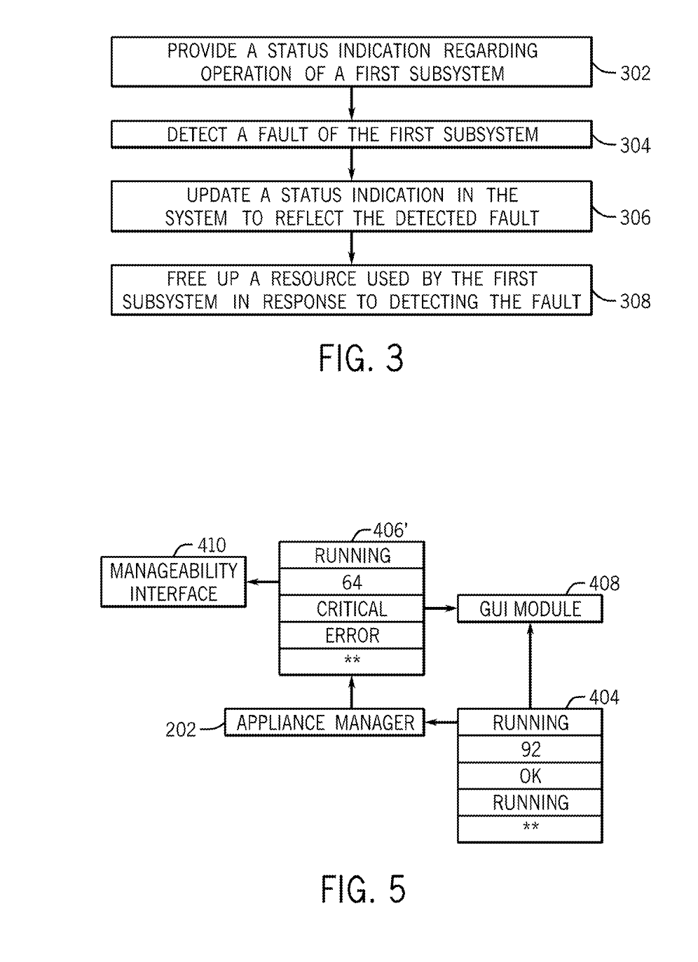

FIG. 3 is a flow diagram of a process according to some implementations. The process can be performed in the system 100 or storage system 200 of FIG. 1 or 2, respectively. According to FIG. 3, a first subsystem provides (at 302) a status indication regarding operation of the first subsystem. In the context of FIG. 1, the first subsystem can refer to any of the intermediate subsystems or lower level subsystems. In the context of FIG. 2, the first subsystem can refer to any of the VTL managers or VTL processes. A second subsystem detects (at 304) a fault of the first subsystem. In the context of FIG. 1, the second subsystem can refer to the monitoring subsystem 102 and in the context of FIG. 2, the second subsystem can refer to the appliance manager 202. Alternatively, the second subsystem can refer to an intermediate subsystem (e.g. 104 or 106 in FIG. 1 or 204 or 206 in FIG. 2) if the first subsystem is a lower level subsystem (e.g. 108, 110, 112, or 114 in FIG. 1, or 208, 210, 212, 214, or 216 in FIG. 2).

In response to detecting the fault of the first subsystem, the second subsystem updates (at 306) a status indication provided in the system to reflect the detected fault. The updated status indication can be the status indication of the second subsystem (e.g. the monitoring subsystem 102 or appliance manager 202). Alternatively, the updated status indication can be the status indication of a subsystem at a lower level than the monitoring subsystem, such as the intermediate subsystem 104 or 106 in FIG. 1 or the VTL manager 204 or 206 in FIG. 2. In addition, the second subsystem can update the status indication of the faulty first subsystem, to indicate the fault status of the first subsystem.

Moreover, in response to detecting the fault of the first subsystem, the process of FIG. 3 also frees up (at 308) a resource used by the first subsystem that has experienced the fault. “Freeing up” a resource refers to deallocating the resource such that a resource is no longer marked as being allocated to a particular subsystem, such that the resource is made available to other subsystems. Freeing up a resource can also refer to relinquishing exclusive access of the resource by the particular subsystem (e.g. exclusive access of a given file or database table) so that another subsystem can be able to access the resource. Examples of resources used can include at least one selected from among a memory, a file, a hardware device, a software module (including machine-readable instructions), a database connection (including communication resources and database engine resources), and a session (defined by identifiers, such as addresses, assigned to respective entities involved in communicating in the session).

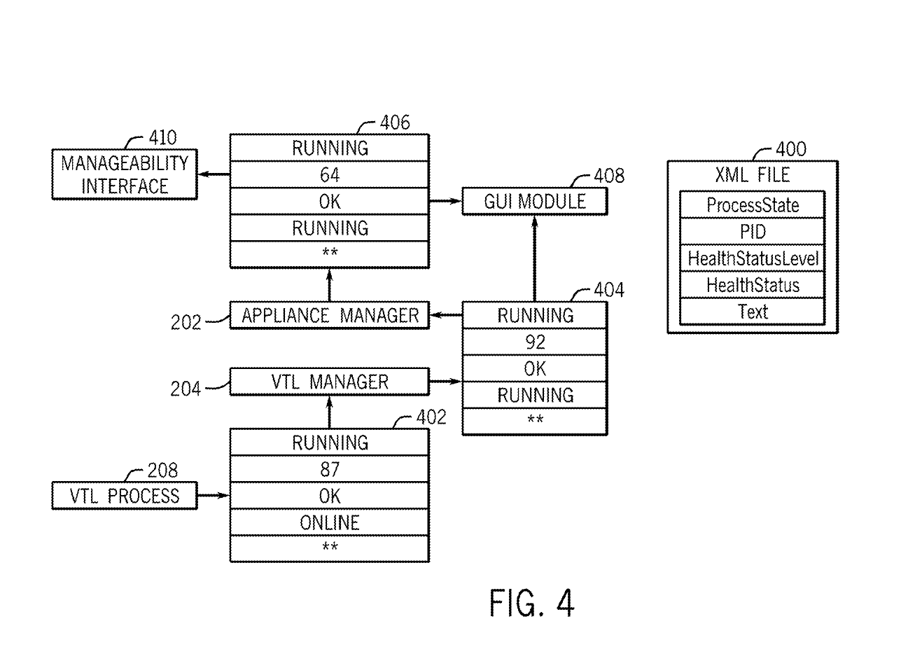

FIG. 4 shows example status indications that can be provided by various subsystems in the storage system 200 of FIG. 2. In FIG. 4, the VTL process 208 provides status indication 402, which can be in the form of an XML file, for example.

In examples according to FIG. 4, status indications generally have a format according to XML file 400. The XML file 400 has various fields, including a ProcessState field to identify a state of a respective subsystem, a PID (process identifier) field to identify the respective subsystem, a HealthStatusLevel field to identify a health level of the respective subsystem, a HealthStatus field to indicate how well the respective subsystem is running, and a Text field containing text that can be entered by the respective subsystem. Note that just some fields are depicted, as the XML file 400 can include additional fields. In other examples, the XML file 400 can include alternative fields.

In the status indication 402, the ProcessState field has value “Running” (to indicate that the VTL process 208 is running normally), the PID field has value “87” (the process ID of the VTL process 208), the HealthStatusLevel field has value “OK” (to indicate that the VTL process 208 has an acceptable health level), the HealthStatus field has value “Online” (to indicate that the VTL process 208 is online), and the Text field has corresponding text. The ProcessState field of the status indication 402 can potentially have other states, including “Starting” (to indicate that the subsystem is starting), “Failed to start” (to indicate that the subsystem has failed to start), “Fault” (to indicate that the subsystem has experienced a fault), “Stopping” (to indicate that the subsystem is stopping), and “Stopped” (to indicate that the subsystem has stopped). The foregoing potential states are provided for purposes of example, as other or alternative states can be used in other implementations.

The HealthStatusLevel field can have levels other than “OK,” such as “Information” (to indicate that the respective subsystem has information that should be retrieved by a monitoring subsystem), “Warning” (to indicate that there is potentially an issue that can cause a fault), and “Critical” (to indicate that a fault has occurred, either in the reporting subsystem or in a lower level subsystem). Although various health levels are provided above, it is noted that in other examples, additional or alternative health levels can be reported.

The HealthStatus field can also have values other than “Online,” such as “Running” (to indicate that the respective subsystem is operational), and “Error” (to indicate that a fault has occurred). Other or alternative HealthStatus field values can be used in other examples.

In some implementations the HealthStatus field is used to indicate how well a respective subsystem is performing, while the ProcessState field is used for managing startup of the respective subsystem and associated ordering of dependencies among subsystems. The ProcessState field can also be used for monitoring by the monitoring subsystem (e.g. 102 in FIG. 1 or 202 in FIG. 2).

In other example implementations, just one of the ProcessState field and HealthStatus field can be present in a status indication.

As further shown in FIG. 4, the status indication 402 output by the VTL process 208 can be provided to the VTL manager 204. The VTL manager 204 in turn outputs a status indication 404, which has corresponding values for respective fields of the XML file 400.

The status indication 404 output by the VTL manager 204 is provided to the appliance manager 202, which in turn also outputs its respective status indication 406. The status indication 406 can be provided to a GUI module 408, and/or another manageability interface 410. In some examples, the status indication 404 that is output by the VTL manager 204 can also be received by the GUI module 408. Thus, the GUI module 408 can be used to present status indications associated with various subsystems (including the appliance manager 202 and the VTL manager 204, as examples) to a user, such as an administrator.

FIG. 5 shows an example where the VTL manager 204 has failed. The failure of the VTL manager 204 means that the underlying VTL process 208 has also failed. Note that the status indication 404 that was output by the VTL manager 204 in the example of FIG. 4 has not been updated in FIG. 5, even though the VTL manager 204 has failed. Thus, the status indication 404 incorrectly indicates that the ProcessState field of the VTL manager 204 has value “Running,” that its HealthStatusLevel has value “OK,” and that its HealthStatus field has value “Running.”

The appliance manager 202 can intermittently poll the VTL manager 204 to determine if the VTL manager 204 is still running. Alternatively, a heartbeat mechanism can be employed, where a heartbeat message is sent by the VTL manager 204 to the appliance manager 202 intermittently. Failure to receive a heartbeat message after some predefined time interval is indicative of failure of a component that was supposed to have sent the heartbeat message.

In response to detecting failure of the VTL manager 204, the appliance manager 202 updates its status indication 406′, to reflect that its HealthStatusLevel is “Critical,” and that its HealthStatus is “Error.” Note that the ProcessState field of the status indication 406′ still has value “Running” to reflect that the appliance manager 202 is still able to run successfully, even though the appliance manager 202 is reporting that its HealthStatusLevel is “Critical” and that its HealthStatus is “Error.”

Although not shown in FIG. 5, note that the appliance manager 202 can also update the status indication 404 (that was previously output by the failed VTL manager 204) to indicate the fault status of the VTL manager 204.

In addition to being able to update a status indication in response to detecting fault of a subsystem, a monitoring subsystem (such as 102 in FIG. 1 or 202 in FIG. 2) according to some implementations can also monitor resources used by various subsystems. The resources that are used by the subsystems can be tracked by the monitoring subsystem in respective resource utilization lists, where the resource utilization lists can be associated with identifiers of the subsystems. Thus, a first subsystem can be associated with a first resource utilization list, a second subsystem can be associated with a second resource utilization list, and so forth. Each resource utilization list identifies the resource(s) used by (allocated to) the respective subsystem.

In some examples, the tracking of resources can involve use of an IPCS (interprocess communication status) utility, LSOF (list open files) utility, NETSTAT (network statistics) utility, or any other mechanism (including vendor-specific utilities and so forth). In some implementations, the monitoring subsystem can provide an aggregate view of all the resources used by the subsystems that the monitoring subsystem is monitoring. Upon detection of a fault of a particular subsystem, the corresponding resource utilization list can be retrieved by the monitoring subsystem to identify the resource(s) that were used by the particular subsystem at the time of the fault. The resource(s) identified by the resource utilization list can be freed up (task 308 in FIG. 3) by the monitoring subsystem, which can involve deallocating any resource previously allocated to the particular subsystem or relinquishing exclusive access of a resource.

Upon detecting a fault of a subsystem, the monitoring subsystem can effect a remedial action. One such remedial action is to provide a message to another entity, such as a user or an automated entity. Alternatively, the monitoring subsystem can cause restart of the subsystem that has experienced the fault. In some cases, a subsystem that has experienced a fault may not have actually failed—the subsystem may continue to run, but may be running in a faulty state (where the subsystem is not operating correctly). In such scenario, the monitoring subsystem can cause the forced failure of the faulty subsystem, such that further remedial action (e.g. restart) can be taken after the subsystem has actually failed.

By being able to detect faulty subsystems and to take remedial actions in response to detecting faulty subsystems, such faults can be addressed before errors are propagated in the system. Moreover, by being able to free up resources previously allocated to faulty subsystems, the reallocated resources can be made available to other subsystems. Moreover, by using the monitoring subsystem to free up resources associated with a faulty subsystem, the subsystem does not have to be provided with code for tidying up previously allocated resources upon restart of the subsystem.

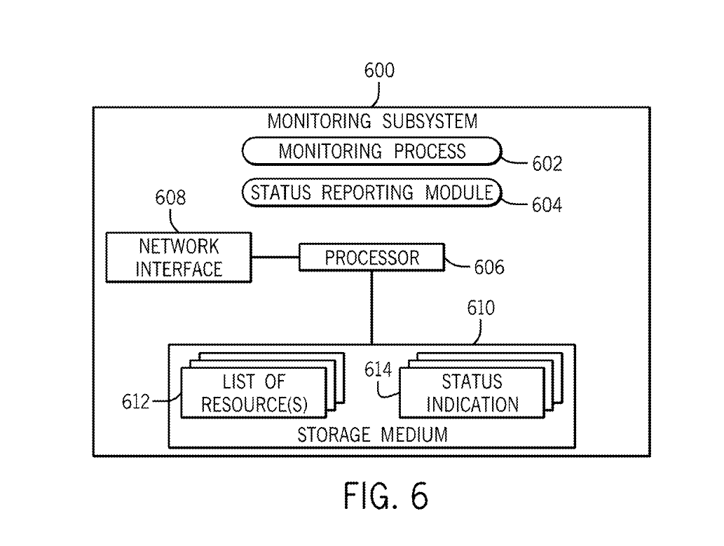

FIG. 6 is a block diagram of an example monitoring subsystem 600 according to some implementations. The monitoring subsystem 600 can be implemented as a computer system, or can be implemented as a distributed arrangement of computer systems. The monitoring subsystem 600 includes a monitoring process 602 and a status reporting module 604. The monitoring process 602 can perform various tasks discussed above, including, for example, the process of FIG. 3. The status reporting module 604 is used for generating a status indication, such as the status indication 406 or 406′ shown in FIG. 4 or 5, respectively.

The monitoring process 602 and status reporting module 604 can be implemented as machine-readable instructions that are executable on one or multiple processors 606. A processor can include a microprocessor, microcontroller, processor module or subsystem, programmable integrated circuit, programmable gate array, or another control or computing device.

The monitoring subsystem 600 also includes a network interface 608 to allow the monitoring subsystem 600 to communicate over a network. In addition, the monitoring subsystem 600 includes a storage medium (or storage media) 610 for storing various information, including lists 612 of resources used by respective subsystems being monitored by the monitoring subsystem 600. The monitoring subsystem 600 can also store various status indications 614 (including the status indication output by the monitoring subsystem 600 as well as the status indications received from other subsystems) in the storage medium or storage media 610.

Although FIG. 6 shows components of a monitoring subsystem, note that other subsystems (such as those depicted in FIG. 1 or 2) can have similar arrangements.

The storage medium or storage media 610 can be implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method for fault processing in a system having a processor, comprising:
providing, by a first subsystem, a status indication regarding operation of the first subsystem;
detecting, by a second subsystem, a fault of the first subsystem; and
in response to detecting the fault of the first subsystem,
the second subsystem updating a status indication to reflect the detected fault: and
freeing up a resource used by the first subsystem that has experienced the fault.

2. The method of claim 1, wherein the second subsystem is a monitoring subsystem.

3. The method of claim 1, wherein freeing up the resource is performed by a monitoring subsystem that tracks resources used by subsystems in the system.

4. The method of claim 3, wherein tracking the resources used by the subsystems comprises tracking resources selected from among a memory, a file, a hardware device, a software module, a database connection, and a session.

5. The method of claim 1, further comprising:
maintaining lists of resources for respective subsystems in the system, the lists being associated with respective identifiers of the subsystems; and
retrieving the list associated with the identifier of the first subsystem to identify the resource used by the first subsystem.

6. The method of claim 1, wherein the status indications comprise corresponding XML (Extensible Markup Language) files.

7. The method of claim 1, further comprising performing a remedial action in response to the status indication updated by the second subsystem.

8. The method of claim 7, wherein performing the remedial action comprises restarting the first subsystem.

9. The method of claim 7, wherein performing the remedial action comprises causing failure of the first subsystem to allow further remedial action to be taken with respect to the first subsystem.

10. The method of claim 1, wherein the system has subsystems in a hierarchical arrangement, the second subsystem being at a top level of the hierarchical arrangement, the first subsystem being at a lower level of the hierarchical arrangement, and wherein the system further includes a subsystem at an intermediate level between the top level and lower level.

11. An article comprising at least one machine-readable storage medium storing instructions for fault processing in a system, the instructions upon execution causing the system to:
receive a status indication regarding operation of a first subsystem;
detect a fault of the first subsystem, wherein the status indication incorrectly indicates the first subsystem as operating normally even though the first subsystem has experienced the fault;
update a status indication provided by a second subsystem in response to detecting the fault; and
free up a resource used by the first subsystem in response to detecting the fault.

12. The article of claim 11, wherein detecting the fault comprises one of polling the first subsystem or using a heartbeat mechanism with the first subsystem.

13. The article of claim 11, wherein the instructions upon execution cause the system to further:
update the status indication of the first subsystem in response to detecting the fault.

14. The article of claim 11, wherein the instructions upon execution cause the system to further:
track resources used by the subsystems of the system; and
provide lists of the tracked resources, wherein the lists are associated with corresponding identifiers of the subsystems.

15. A system capable of performing fault processing, comprising:
at least one processor to:
receive a status indication regarding operation of a first subsystem;
detect a fault of the first subsystem, wherein the status indication incorrectly indicates the first subsystem as operating normally even though the first subsystem has experienced the fault;
update a status indication provided by a second subsystem in response to detecting the fault; and
free up a resource used by the first subsystem in response to detecting the fault.
